(19) United States
(12) Patent Application Publication
(10) Pub. No.: US 2011/0203267 A1
(43) Pub. Date: Aug. 25, 2011

(54) Method and device for operating a stirling cycle process

(75) Inventors: Klaus Ramming, Mainleus (DE); Michael Delchsel, Kulmbach (DE)

(73) Assignee: AGO AG Energie + Anlagen AG

(21) Appl. No.: 13/065,993

(22) Filed: Apr. 4, 2011

Related U.S. Application Data
(63) Continuation of application No. PCT/EP2009/062112, filed on Sep. 18, 2009.

(30) Foreign Application Priority Data
Oct. 14, 2008 (DE) DE 102008042828.0

(51) Int. Cl. F02G 1/043; F02G 1/044

(52) U.S. Cl. 60/525; 60/517

(57) ABSTRACT

In a method for operating a Stirling cycle process an operating medium is essentially compressed in an isothermal manner, subsequently heated in an isochoric manner subsequently expanded in an isothermal manner and subsequently cooled in an isochoric manner which completes the cycle process. In order to improve the energy efficiency of such processes for a clockwise power machine process and also for a counterclockwise refrigeration machine it is proposed that the isothermal compression be performed freely through a liquid piston compressor (2) and/or the isothermal expansion is performed by a liquid piston expander. Additionally a device for carrying out the method is disclosed.

### RELATED APPLICATIONS

This patent application is a continuation of International patent application PCT/EP2009/062112, filed on Sep. 18, 2009 claiming priority from and incorporating by reference German patent application DE 10 2008 042 828.0, filed on Oct. 14, 2008, both of which are incorporated herein by this reference.

### FIELD OF THE INVENTION

The invention relates to a method for operating a Stirling cycle process in which an operating medium is respectively compressed in an isothermal manner, subsequently heated in an isochoric manner subsequently, expanded in an isothermal manner and subsequently cooled in an isochoric manner which completes the cycle process.

The invention furthermore relates to a device for operating a Stirling process including a compressor for essentially isothermal compression of an operating medium under heat dissipation, a heat transfer device through which heat can be essentially transferred to the compressed operating medium essentially in a isochoric manner, an expansion device for essentially isothermal expansion of the operating medium under heat absorption, wherein heat is transferable in a heat exchanger from the expanded operating medium to the compressed operating medium and wherein the cooled operating medium is subsequently supplyable to the compressor again.

### BACKGROUND OF THE INVENTION

The Stirling process and devices to perform the Stirling process have been known in the art for a long time. The Stirling process is one of the cycle processes in which the efficiency of a clockwise Carnot process can be achieved for a clockwise power machine process, or the figure of merit of a counter clockwise Carnot process can be reached for a counterclockwise Stirling process (heat pump, refrigeration machine). Based on multiple restrictions in practical applications of the method and based on engineering and material limitations the actually achieved efficiency or figure of merit is always not as good as theoretically possible.

The language “essentially” isothermal compression or expansion and “essentially” isochoric heating or cooling recited supra therefore shall also include changes of state which deviate from the thermodynamic ideal process due to practical restrictions which, however, are at least approximated to the isothermal or isochoric changes of state.

A disadvantage of the Stirling process typically performed through piston compressors or piston expanders is the comparatively bad heat transfer from the operating medium to an ambient medium that surrounds the operating medium or is in contact with the operating medium. In practical applications therefore the compression process and also the expansion process occur comparatively remote from the idealized isothermal state change. This affects the efficiency of the power machine process or the figure of merit for a refrigeration machine- or heat pump process.

A liquid piston engine is known from U.S. 2008/0072597 A1 in which an electrically or electronically conducted liquid is being used. The known motor includes a first “hot” cylinder, in whose upper section a gas is supplied with heat through an external heat source. The gas is disposed above the level of a liquid piston whose liquid is electrically or electronically conductive. Another cylinder is designated as a “cold cylinder” and gas is disposed in this cylinder also above the level of a liquid piston which is formed by the same liquid as in the hot cylinder. A gas exchange can be performed between the hot cylinder and the cold cylinder respectively through a connection conduit opening at a top side of both cylinders. Through another connection conduit opening at a respective bottom side of the two cylinders liquid can be pumped from a hot cylinder into a cold cylinder or vice versa. A second distributor conduit branches off from the upper gas connection conduit, wherein the distributor conduit is run to a generator which is placed in a type of siphon and in which an electrically or electronically conductive liquid is disposed. When the hot cylinder is mostly filled with gas and the gas is heated by a heat source an expansion occurs and the gas loads the liquid surface through the divider conduit on one side of the magneto-hydrodynamic generator, which causes the magneto-hydrodynamic generator to generate electrical energy from work. After the end of the expansion the hot gas is transferred into the cold cylinder through filling the hot cylinder with the fluid using the magneto-hydrodynamic pump, wherein a volume reduction occurs as a consequence of the cooling and conductive liquid can also flow back into the magneto-hydrodynamic generator. After a subsequent filling of the hot cylinder with cold gas and activating the heat source the process can start again.

The known motor has the advantage that no moving mechanical components like valves, flaps, or similar are required which yields low maintenance requirements and high service life. The gaseous operating medium, however, is not run in a cycle in the known process, but it oscillates back and forth between the two cylinders and includes an open conduit for the generator which is open at its free end towards ambient for utilizing the expansion work.

### BRIEF SUMMARY OF THE INVENTION

Thus it is an object of the invention to improve a method for operating a Stirling cycle process and a device for performing a method of this type, so that the efficiency of the power machine process or the figure of merit of the refrigeration machine or heat pump process are increased.

Based on the method described supra the object is achieved in that isothermal compression is performed through a liquid piston compressor and/or isothermal expansion is performed through a liquid piston expander.

Liquid pistons have an advantage over pistons with solid rigid components with exactly defined geometry in that the cylinders in which the compression or expansion process occurs can have any geometry, since the liquid piston always adapts self acting and thus provides absolute tightness for the operating cavity. Therefore cylinders with a very good surface/volume ratio can be implemented, which is not possible for classic pistons with fixed geometry, since the sealing problem would not be solvable in this case. Thus, for example, the cylinder can be permeated by a heat exchanger bundle, so that very large surfaces are obtained for a heat transition between the operating medium and a second medium. The better the heat transition from the operating medium to another medium, the better an isothermal state change can be reached for the compression and also for the expansion. The closer this comes to implementing an ideal isothermal state change, the more the efficiency or the figure of merit of the process approaches the values possible in the respective Carnot process. As a result the method according to the invention can provide significantly improved energy efficiency for the clockwise Stirling cycle process and also for the counterclockwise Stirling cycle process.

The hydraulic fluid forming the liquid piston of the liquid piston compressor, wherein the hydraulic fluid must not be mixable with the operating medium under any circumstances, is pumped by a hydraulic pump with work being added. Accordingly, a hydraulic fluid forming the liquid piston of the liquid piston expander is expanded by a hydraulic motor while performing work. Typically, the liquid piston compressor and also the liquid piston expander operate in the same hydraulic fluid cycle.

According to an advantageous embodiment of the method according to the invention hydraulic fluid exiting from the liquid piston expander alternatively impacts the liquid piston compressor and/or a hydraulic motor and/or it can be stored in a pressure container, from which either the liquid piston compressor and/or the hydraulic motor is loadable with hydraulic fluid.

In order the be able to compensate shifts on a time basis between the expansion process and the compression process a regenerative heat transfer device can be used, through which heat from the operating medium is transferred after isothermal compression in an isochoric manner to the operating medium in particular of the same operating medium cycle, before the operating medium is expanded in an isothermal manner. When no phase shifts have to be compensated, a recuperative heat transfer device can also be used and a heat transfer can be performed to an operating medium of another cycle.

Alternatively thereto it is also possible to run the operating medium in two cycles that are separated from one another from a material point of view and respectively include a liquid piston compressor and a liquid piston expander and wherein heat is transferred in a first heat exchanger in an isochoric manner from the operating medium leaving the liquid piston expander of the first cycle to the operating medium leaving the liquid piston compressor of the second cycle and heat is transferred in a second heat exchanger in an isochoric manner from the operating medium leaving the liquid piston expander of the second cycle to the operating medium leaving the liquid piston compressor of the first cycle, wherein the cycle processes in both cycles are performed phase shifted by half a phase relative to one another. The hydraulic cycles can be implemented separately, but also coupled to one another.

In order to achieve high efficiency or a high figure of merit in a refrigeration machine/heat pump process it is helpful to select a temperature level of the upper (isothermal compression) or expansion as high as possible. In order to avoid problems with thermal stability of the hydraulic fluid in this case, it is useful that two Stirling cycle processes are performed that are separated from one another from a material point of view with respect to their operating media and also with respect to their hydraulic fluids, wherein the lower temperature level of a high temperature process coincides with the upper temperature level of a low temperature process and the heat dissipated during isothermal compression of the operating medium of the high temperature process is absorbed by the operating medium of the low temperature process during its isothermal expansion. In case of a counterclockwise refrigeration machine/heat pump process the heat absorbed by isothermal expansion of the operating medium of the high temperature process is dissipated by the operating medium of the low temperature process during its isothermal compression. In particular a liquid metal can be used as a hydraulic medium for the high temperature process, whereas typically mineral oils are being used for the low temperature process.

From a device point of view the object is achieved through a device according to the invention as described supra in that the compressor is a liquid piston compressor and/or the expander is a liquid piston expander. This facilitates optimizing the energy efficiency of the process by optimizing the heat transfer in combination with the cylinders of the compressor or expander that are configured with the respective sizes.

According to an embodiment of the device according to the invention a hydraulic cycle is provided which is operable by the liquid piston of the liquid piston compressor and/or the liquid piston expander, wherein the hydraulic cycle includes a hydraulic motor and/or a hydraulic pump and/or a container, in particular a pressure vessel. Furthermore a regenerative or recuperative heat transfer device can be used through which heat is transferable from the operating medium after its isothermal expansion to the operating medium after its isothermal compression. In the refrigeration machine/heat pump process the conditions are reversed accordingly.

An improvement from a device point of view is using two liquid piston compressors and tow liquid piston expanders, wherein one liquid piston compressor and one liquid piston expander are respectively tied into an independent operating medium cycle and a heat exchange between the two operating media cycles is performed through at least one heat exchanger tied into both cycles.

In the switching variant recited supra it is also possible that the heat transfer device is jointly formed by the liquid piston compressor of the first operating medium cycle with the liquid piston expander of the second operating medium cycle, wherein the liquid piston compressor and liquid piston expander include common heat exchanger surfaces, so that when the operating medium is expanded in the first operating medium cycle, the operating medium is compressed in the second operating medium cycle and thus with a respective heat exchange between the two operating medium cycles.

Eventually, it is also provided according to the invention to implement a device with eight cylinders, this means a device with four liquid piston compressors and four liquid piston expanders, wherein four groups respectively including a liquid piston compressor and a liquid piston expander respectively include an independent operating medium cycle, wherein hydraulic fluid of all four liquid piston compressors and of all four liquid piston expanders is run in a common cycle with a single hydraulic motor or a single hydraulic pump and the Stirling processes in the four operating medium cycles are preformed with a phase shift of a quarter phase relative to one another.

### BRIEF DESCRIPTION OF THE DRAWINGS

The method according to the invention and the associated device are subsequently described in more detail with reference to embodiments illustrated in the drawing figured wherein:

FIG. 1 illustrates an idealized Stirling process and a real Stirling process using a piston compressor and a piston expander in a p-v diagram;

FIG. 2 illustrates the process of FIG. 1 in a T-s diagram;

FIG. 3 illustrates the process of FIG. 1 using a liquid piston compressor and a liquid piston expander;

FIG. 4 illustrates the process of FIG. 2 using a liquid piston compressor and a liquid piston expander;

FIG. 5 illustrates a schematic system diagram with a liquid piston compressor and a liquid piston expander;

FIG. 6 illustrates a schematic system diagram with two liquid piston compressors and two liquid piston expanders and 2 separate operating medium cycles;

FIG. 7 illustrates a schematic system diagram with two liquid piston expanders and two liquid piston compressors and two separate operating medium cycles, however with heat transition between the two cycles in the portion of a combined liquid piston compressor/liquid piston expander;

FIG. 8 illustrates a 2 stage Stirling cycle according to the system diagrams of FIG. 7 in a T-s diagram; and

FIG. 9 illustrates a schematic system diagram with 4 liquid piston expanders and 4 liquid piston compressors.

### DETAILED DESCRIPTION OF THE INVENTION

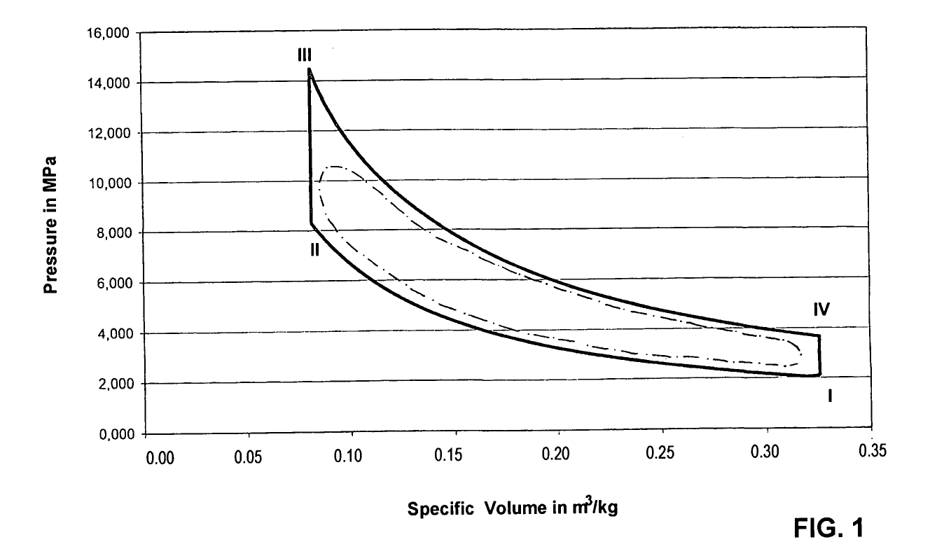

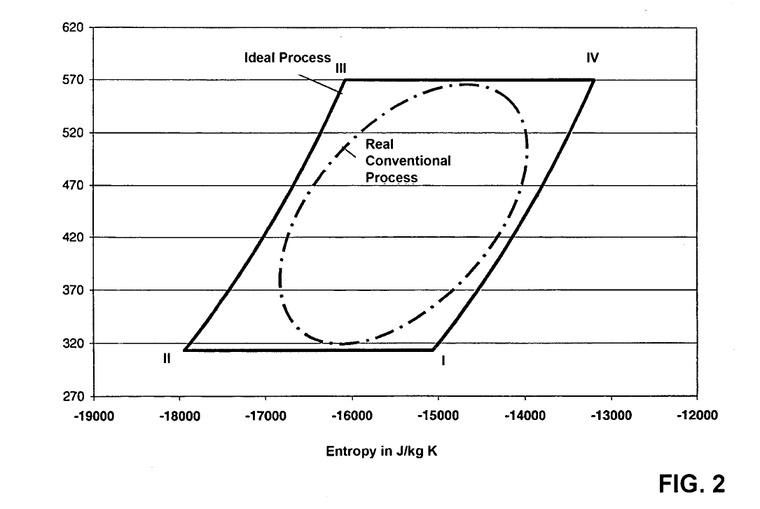

An idealized Stirling process illustrated in FIGS. 1 and 2 in a p-v diagram and in a T-s diagram starts at point I with an isothermal compression at a low temperature level until point II is reached. Based on this, isochoric heating is performed up to point III, from where the operating medium is expanded again in an isothermal manner at a high temperature level. From the end point IV of the expansion isochoric cooling is performed up to the starting point I. The highest pressure (c.f. FIG. 1) is thus reached in the point at the end of the isochoric heating and the lowest pressure is reached in point I at the end of the isochoric expansion.

For a heat pump/power machine process the same process is performed in an opposite direction (counterclockwise Stirling process). As a result mechanical work is added, whereas mechanical work is generated in a power machine process.

FIGS. 1 and 2 illustrate a real Stirling process with dash-dotted lines as it is performed using classic piston compressors and piston expanders. It is clearly visible that the “corners” of the ideal process, where the different state changes are precisely defined over one another, do not exist in reality. Rather, a rounded curve/line is provided, since the state changes neither occur in an isothermal manner, nor in an isochoric manner. The deviations from the idealized process negatively affect the efficiency of the power machine process and the figure of merit of the heat pump/refrigeration machine process.

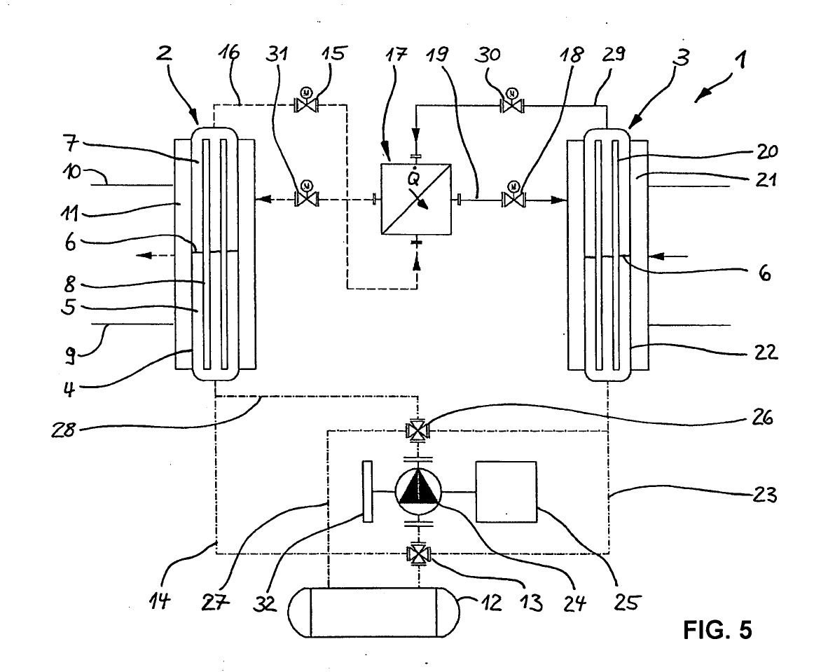

Thus, FIG. 5 illustrates a schematic system diagram of a device 1 according to the invention including a liquid piston compressor 2 and a liquid piston expander 3 and thus omits the typical prior art piston units. The liquid piston compressor 2 includes a cylinder 4 with a hydraulic fluid 5 disposed in the lower position of the cylinder, wherein the hydraulic fluid forms a level 6 in an interior 7 of the cylinder 4. In the interior 7 there is furthermore a tube bundle 8 of a heat exchanger which is flowed through by a heat transfer medium. The heat transfer medium flows through an intake conduit 9 and an outlet conduit 10 through the tube bundle 8 and also through a cavity 11 that is formed in a double jacket, wherein the cavity 11 surrounds the interior 7 of the cylinder 4.

During the compression stroke in the liquid piston compressor 2 the hydraulic fluid 5 is pumped into the interior 7 of the cylinder 4 under the require pressure. Thus, the hydraulic fluid is removed from a pressure vessel 12 in the required quantity and run through a motorically actuated valve 13 and a conduit 14 into the inner cavity 7 of the cylinder 4.

After a compression of the operating medium in the liquid piston compressor 2a valve 15 in a conduit 16 and a valve 18 in a conduit 19 are simultaneously opened. Thereafter the operating medium flows through a heat exchanger 17. Therein the operating medium is heated in an isochoric manner and flows onward into the liquid piston expander 3, where an isothermal expansion occurs while lowering the hydraulic fluid level 6 therein. Thus, heat is transferred through a heat transfer medium to the operating medium through a tube bundle 20 and a cavity 21 configured as a double jacket about the cylinder 22.

The hydraulic fluid displaced from the cylinder 22 of the liquid piston expander 3 under high pressure flows through a conduit 23 and the valve 13 into a hydraulic motor 24 which drives a generator 25 for generating electrical energy. The hydraulic fluid then flows through another valve 26 and a conduit 27 into the pressure vessel 12 or through a conduit 28 into the liquid piston compressor 2.

After the isothermal expansion of the operating medium a valve 30 disposed in a conduit 29 opens and the valve 31 simultaneously opens. Thereafter the operating medium flows through the heat exchanger 17 where it transfers heat in an isochoric manner to the operating medium flowing from the liquid piston compressor 2 to the liquid piston expander 3.

The cycle process is completed in that the cooled operating medium flows back into the liquid piston compressor 2 until the level 6 of the hydraulic fluid is at its bottom dead center, so that a new compression stroke can begin after the valve 31 is closed.

Due to the phase shift of the flow through of the heat exchanger 17 it has to be provided in a regenerative configuration. In order to compensate for the cyclic fluctuations in the loading of the hydraulic motor 24 and the generator 25 connected therewith, a flywheel 32 is arranged on the common shaft of the two recited units wherein the large mass of the flywheel sufficiently smoothes the rotation of the generator 25. Sufficient energy is always provided in this manner in order to pump hydraulic fluid into the liquid piston compressor during a compression stroke.

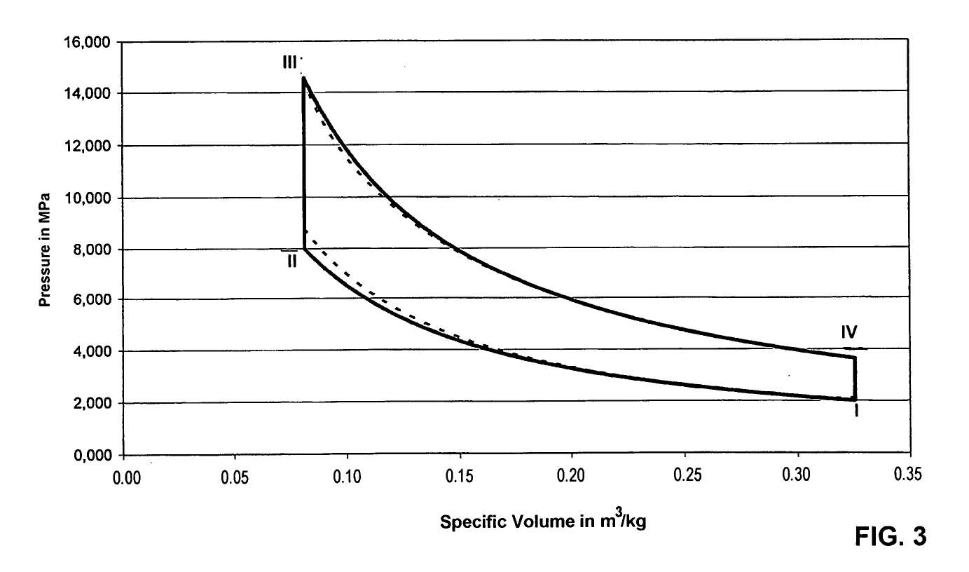

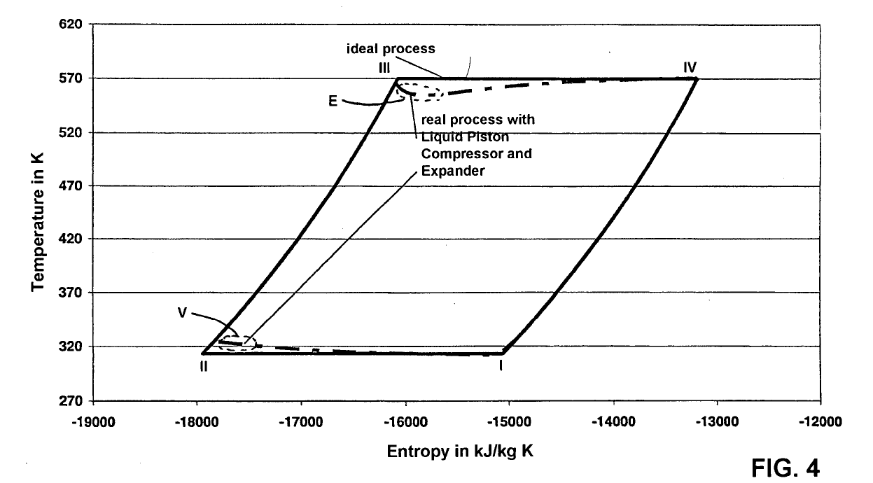

By using the liquid piston compressor 2 and the liquid piston expander 3, the state changes occurring therein are approximated very well to the isotherms of the Stirling process. This is illustrated in FIGS. 3 and 4 from which it is apparent that contrary to the diagrams according to FIGS. 1 and 2 the state changes during compression and expansion occur with much lower temperature changes. Only at the end of the compression there are significant undesirable temperature increases in the portion V. At the beginning of the expansion in the portion E an undesirable temperature decrease occurs compared to the isothermal state change.

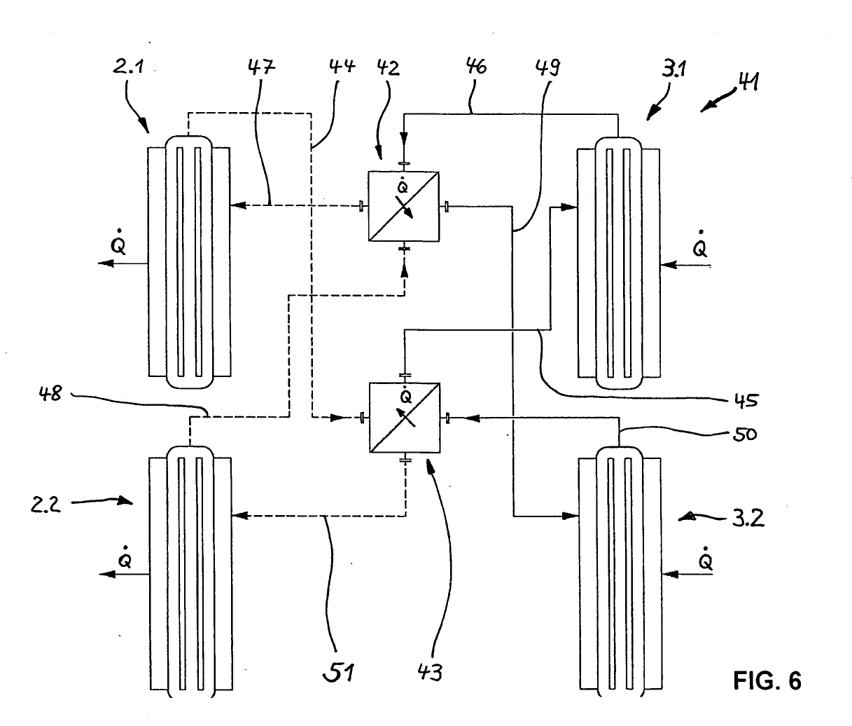

Another embodiment of the device 41 according to the invention according to FIG. 6 includes two liquid piston compressors 2.1, 2.2 and two liquid piston expanders 3.1 and 3.2. There are two operating medium cycles which are materially separated from one another, into which two respective heat transfer devices 42, 43 are tied.

In the first operating cycle the operating medium after its compression in the liquid piston compressor 2.1 flows through a conduit 44 to a heat exchanger 43 where it absorbs heat and subsequently moves through a conduit 45 into the liquid piston expander 3.1. From there it flows after expansion through a conduit 46 to a heat exchanger 42 where it dissipates heat. Subsequently the fluid returns again through a conduit 47 into the liquid piston compressor 2.1.

In the second cycle the operating medium after its compression in the liquid piston compressor 2.2 flows through a conduit 48 to the heat exchanger 42 where it absorbs heat and subsequently moves through a conduit 49 to the liquid piston expander 3.2. The operating medium leaves the expander 3.2 after its expansion through a conduit 50 in a direction towards the heat exchanger 43, from which it moves after heat dissipation through a conduit 51 back into the liquid piston compressor 2.2.

Separating the two cycles facilitates simultaneously loading the two heat exchangers which are respectively flowed through by the operating medium, so that simple recuperative heat exchangers can be used.

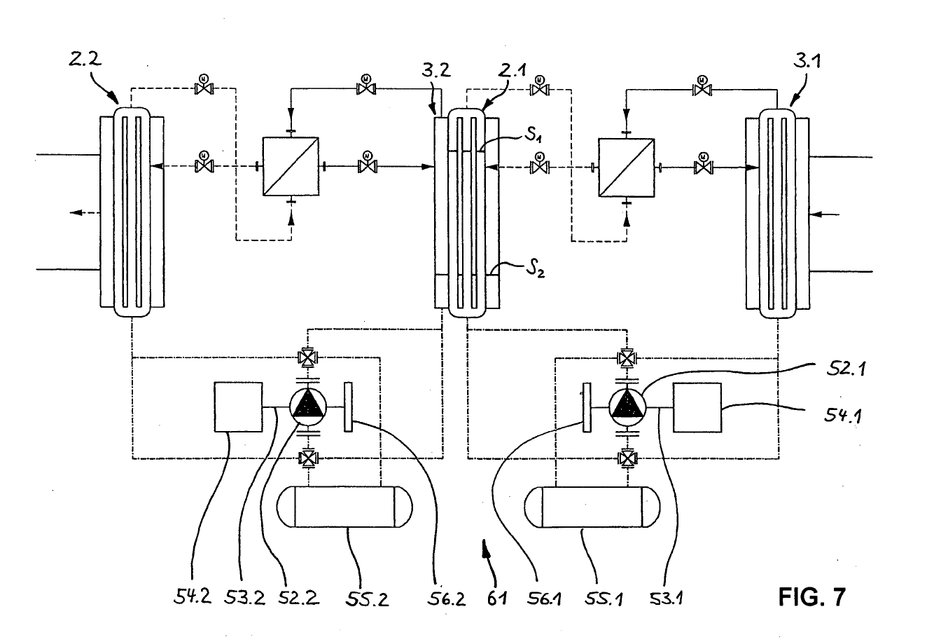

FIG. 7 eventually illustrates another embodiment of the invention in which a device 61 in turn is respectively provided with two liquid piston compressors 2.1, 2.2 and two liquid piston expanders 3.1, 3.2. Like in the embodiment according to FIG. 6 the two cycles of the operating medium are materially separated from one another. The temperature levels in the two cycles, however, are different and thus the upper temperature level of the low temperature cycle NT coincides with the lower temperature level of the high temperature cycle HT. The liquid piston compressor 2.1 of the high temperature cycle HT is thermally coupled with the liquid piston expander 3.2 of the low temperature cycle NT, so that heat that is dissipated during the compression in the high temperature cycle HT is absorbed during the expansion in the low temperature cycle NT. The liquid piston compressor 2.1 of the high temperature cycle HT thus forms the heat source for the heat sink that is provided in the form of the liquid piston expander 3.2 in the low temperature cycle NT.

Based on the different temperature levels in the two operating media cycles also the hydraulic cycles should be materially separated from one another. Thus, selecting a liquid metal as a hydraulic fluid is useful for the high temperature cycle HT, whereas mineral oils can typically be used in the low temperature cycle NT.

This way it is prevented that the hydraulic fluid causes a temperature shift between the high temperature cylinders and the low temperature cylinders. This would negatively influence the temperature diagrams during compression and expansion which would yield very low efficiency.

The two combined hydraulic motors or hydraulic pumps 52.1, 52.2 thus impact separate shafts 53.1, 53.2 respectively with one generator 53.1, 54.2 and one flywheel 56.1, 56.2.

Each hydraulic loop has its own container 55.1, 55.2. When the device 61 illustrated as a power machine in FIG. 7 is to be operated as a heat pump/refrigeration machine electric motors have to be used instead of the generators 54.1, 54.2, wherein the rotation of the electric motors has to be reversed, whereby the material flows in the hydraulic cycles and also in the operating medium cycles also run in opposite directions.

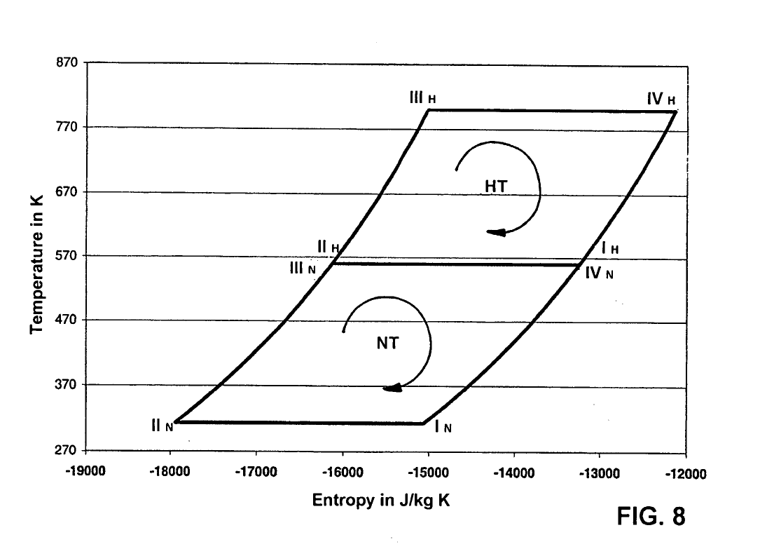

FIG. 8 illustrates a T-s diagram for the process occurring in the device 61 according to FIG. 7. In the high temperature cycle HT the included operating medium is compressed in an isothermal manner starting at point I_{H} towards II_{H}, subsequently the operating medium is heated in an isochoric manner towards the point III_{H}, subsequently expanded towards point IV_{H} and eventually cooled in an isochoric manner back to point Iₕ.

On the other hand the operating medium is compressed in an isothermal manner in the low temperature cycle NT starting at point I_{N} towards II_{N} subsequently heated in an isochoric manner towards point III_{N} (=II_{H}). An isothermal expansion occurs from point III_{N} to point IV_{N} along the same line I_{H}-II_{H} which represented the isothermal compression of the high temperature cycle HT. The heat dissipated during the compression in the high temperature cycle HT is thus absorbed during the isothermal expansion occurring in the low temperature cycle NT.

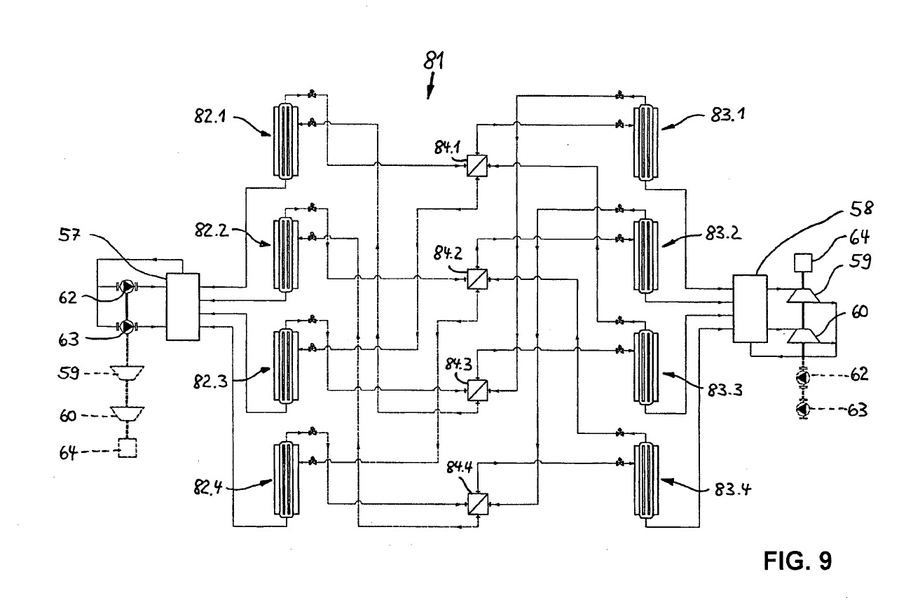

Eventually FIG. 9 illustrates a schematic system diagram of a device 81 with four liquid piston compressors 82.1, 82.2, 82.3, 82.4 and four liquid piston expanders 83.1, 83.2, 83.3, 83.4. Thus, overall four separate operating medium cycles are respectively formed by a liquid piston compressor 82.1, 82.2, 82.3, 82.4 and a liquid piston expander 83.1, 83.2, 83.3, 83.4 in which separate Stirling processes occur respectively. The four processes which are independent with respect to the operating medium are phase shifted so that each process step is performed once in each stroke. Therefore neither a pressure container nor a flywheel are required on the hydraulic side of the device 81 and simple recuperative heat exchangers 84.1, 84.2, 84.3, 84.4 can be used.

Thus a heat exchange occurs in the heat exchanger 84.1 between the operating media of the cycle of the liquid piston compressors/expander 82.1, 83.1 and the liquid piston compressors/expanders 82.3, 83.3 in the heat exchanger 84.2 between the cycles of the liquid piston-compressors/expanders 82.2, 83.2 and the liquid piston compressors-expanders 82.4, 83.4 in the heat exchanger 84.3 between the cycles of the liquid piston compressors/expanders 82.1, 83.1 and the liquid piston—compressors/expanders 82.3, 83.3 and the heat exchanger 84.4 between the cycles of the liquid piston compressors/expanders 82.2, 83.2 and the liquid piston compressors/expanders 82.4, 83.4.

From a hydraulic point of view the hydraulic cycles of the four liquid piston compressors 82.1, 82.2 82.3, 82.4 on one side and the four liquid piston expanders 83.1, 83.2, 83.3, 83.4 on the other side are separated from one another from a material point of view, so that different hydraulic media can be selected as required. In any case this hydraulic separation prevents a temperature drag between the liquid piston expanders 83.1, 83.2, 83.3, 83.4 operating at a higher temperature level and the liquid piston compressors 82.1, 82.2, 82.3, 82.4 operating at the lower temperature level.

Controlling the four liquid piston compressors 82.1, 82.2, 82.3, 82.4 and the four liquid piston expanders 83.1, 83.2, 83.3, 83.4 is respectively performed through a hydraulic control block 57 on the low temperature side and through a hydraulic control block 58 on the high temperature side. The hydraulic medium in the high temperature cycle impacts a shaft through two hydraulic motors 59, 60, wherein two hydraulic pumps 62, 63 are also arranged on the shaft, wherein the hydraulic pumps supply the liquid piston compressors 82.1, 82.2, 82.3, 82.4 through the hydraulic control block 57 with the hydraulic fluid of the low temperature cycle. A generator 64 is also disposed on the common shaft of the two hydraulic pumps 62, 63 and of the two hydraulic motors 59, 60, wherein the generator has to be replaced with an electric motor when the device 81 is used as a heat pump/refrigeration machine. In the present case in which the device 81 is operated as a power machine heat is absorbed at a high temperature level in the liquid piston expanders 83.1, 83.2, 83.3 83.4 and dissipated again by the liquid piston compressors 82.1, 82.2, 82.3, 82.4 at a low temperature level. The generator 64 delivers electrical energy. When operated as a heat pump/refrigeration machine the conditions are reversed accordingly. For the purposes of clarity the hydraulic motors 59, 60 disposed on a single shaft and the hydraulic pumps 62, 63 on the two opposite sides of the system diagram are illustrated twice, wherein the units on one respective side of the diagram are drawn in dashed lines and drawn in full lines on the other side.

While the hydraulic motor 59 is used for expanding high pressures at low volume flows it is an object of the hydraulic motor 60 to use the energy which is released during isochoric displacement of the operating medium by the associated heat exchanger into the respective liquid piston expander. Thus, the hydraulic motor 60 is configured for high pressures and large volume flows. The same applies for the pump side. Thus, the pump 62 is configured for feeding small volume flows under high differential pressures and the pump 63 on the other hand side is configured for feeding high volume flows at below pressure differences, as they occur during “push over” of the operating medium from the compressor side to the expander side. The hydraulic blocks 57, 58 and the system control controlling the hydraulic blocks provide that the required hydraulic path is switched at the correct point in time.

It is appreciated that the principle of separating the hydraulic cycles can already be implemented for a “simple” device with two cylinders according to FIG. 5. In this case the hydraulic medium of the liquid piston compressor 2 is materially separated from the hydraulic medium of the liquid piston expander 3. Thus, two separate containers 12 are being used and a hydraulic pump is used in the compressor loop and a hydraulic motor is used in the expander loop. The hydraulic motor and the hydraulic pump can be disposed on a common shaft which is provided with a flywheel and a generator (optionally a power machine) or with a motor when used as a refrigeration machine/heat pump. Separate shafts and separate flywheels can also be provided.

### REFERENCE NUMERALS AND DESIGNATIONS

1, 41, 61, 81 device
2, 2.1, 2.2, 82.1,
82.2, 82.3 82.4 liquid piston compressor
3, 3.1, 3.2,
83.1, 83.2, 83.3 83.4 liquid piston expander
4 cylinder
5 hydraulic fluid
6 liquid level surface
7 inner cavity
8 tube bundle
9 inlet conduit
10 outlet conduit
11 cavity
12 pressure vessel
13 valve
14 conduit
15 valve
16 conduit
17 heat exchanger
18 valve
19 conduit
20 tube bundle
21 cavity
22 cylinder
23 conduit
24 hydraulic motor
25 generator
26 valve
27 conduit
28 conduit
29 conduit
30 valve
31 valve
42 heat transfer device
43 heat transfer device
44 conduit
45 conduit
46 conduit
47 conduit
48 conduit
49 conduit
50 conduit
51 conduit
NT low temperature loop
HT high temperature loop
52.1 hydraulic motor/pump
52.2 hydraulic motor/pump
53.1 shaft
53.2 shaft
54.1 generator
54.2 generator
55.1 container
55.2 container
56.1 flywheel
56.2 flywheel
57 hydraulic control block
58 hydraulic control block
59 hydraulic motor
60 hydraulic motor
84.1, 84.2, 84.3, 84.4 heat exchanger

What is claimed is:

1. A method for operating a Stirling cycle process, comprising the following steps:
compressing an operating medium in a compressor in an isothermal manner;
heating the operating medium in an isochoric manner;
expanding the operating medium in an expander in an isothermal manner; and
cooling the operating medium in an isochoric manner,
wherein the compressor is a liquid piston compressor or the expander is a liquid piston expander,
wherein a first valve opens after the compressing step and the operating medium flows from the compressor through the first valve into a heat exchanger and from the heat exchanger through a second valve into the expander, and
wherein a third valve opens after the expanding step and the operating medium flows from the expander through the third valve into the heat exchanger and from the heat exchanger through a fourth valve into the compressor.

2. The method according to claim 1, wherein a hydraulic fluid forming the liquid piston of the liquid piston compressor is pumped by a hydraulic pump with labor being added or a hydraulic fluid forming the liquid piston of the liquid piston expander is expanded by a hydraulic motor with labor being performed.

3. The method according to claim 1,
wherein the isothermal compressing step is performed through a liquid piston compressor and the isothermal expansion is performed through a liquid piston expander and the liquid piston compressor and the liquid piston expander impact the same hydraulic fluid,
wherein the hydraulic fluid exiting the liquid piston expander optionally impacts the liquid piston compressor or a hydraulic motor, or is stored in a pressure vessel through which the liquid piston compressor or the hydraulic motor are loadable with the hydraulic fluid.

4. The method according to claim 1, wherein the operating medium transfers heat through a regenerative or recuperative heat transfer device in an isochoric manner to the operating medium after the isothermal compressing step of the operating medium before the isothermal expanding step of the operating medium.

5. The method according to one of the claims 1,
wherein the operating medium is run in two separated loops respectively including a liquid piston compressor and a liquid piston expander,
wherein heat is transferred in a first heat exchanger in an isochoric manner by the operating medium exiting the liquid piston expander of the first loop to the operating medium exiting the liquid piston compressor of the second loop and heat is transferred in a second heat exchanger in an isochoric manner by the operating medium exiting the liquid piston expander of the second loop to the operating medium exiting the liquid piston compressor of the first loop, and
wherein process cycles run in the first and second loops so that they are shifted by a half phase relative to one another.

6. The method according to one of the claims 1,
wherein two Stirling processes are performed which are materially separated from one another with respect to their operating media and their hydraulic fluids, and
wherein the lower temperature level of a high temperature process coincides with the operating temperature level of a low temperature cycle and heat dissipated during isothermal compression of the operating medium of the high temperature process is absorbed by the operating medium of the low temperature process during its isothermal expansion.

7. A device for operating a Stirling cycle process, comprising:
a compressor for compressing an operating medium in an isothermal manner under heat dissipation;
a heat exchanger through which heat is transferable to the compressed operating medium; and
an expander for isothermal expansion of the operating medium under heat absorption,
wherein heat is transferable in the heat exchanger from the expanded operating medium to the compressed operating medium,
wherein the cooled operating medium is subsequently supplyable again to the compressor, and
wherein the compressor is a liquid piston compressor or the expander is a liquid piston expander.

8. The device according to claim 7, further comprising
a hydraulic loop including the liquid piston of the liquid piston compressor or the liquid piston of the liquid piston expander,
wherein the hydraulic loop includes a hydraulic motor or a hydraulic pump or a vessel, in particular a pressure vessel.

9. The device according to claim 7, further comprising a regenerative or recuperative heat exchanger through which heat is transferable from the operating medium after its isothermal expansion to the same operating medium of the same loop or to an operating medium of another loop after its isothermal compression.

10. The device according to one of the claim 7, further comprising:
two liquid piston compressors and two liquid piston expanders,
wherein one respective liquid piston compressor and one respective liquid piston expander are connected in a first and in a second independent operating medium loop and a heat exchange is performed between the first and the second operating medium loop through at least one heat exchanger.

11. The device according to claim 10,
wherein the at least one heat exchanger is formed by the liquid piston compressor of the first operating medium loop in combination with the liquid piston expander of the second operating medium loop, and
wherein the liquid piston compressor and the liquid piston expander include common heat exchanger surfaces, so that a compression of the operating medium in the second operating medium loop occurs during an expansion of the operating medium in the first operating medium loop, providing a respective heat exchange between the first and the second operating medium loop.

12. The device according to claim 11, wherein the hydraulic fluid of the liquid piston expander and of the liquid piston compressor respectively of the first operating medium loop is materially separated from the hydraulic fluid of the liquid piston expander and of the liquid piston compressor respectively of the second operating medium cycle.

13. The device according to one of the claim 7,
wherein the device includes four liquid piston compressors and four liquid piston expanders,
wherein four groups respectively including one liquid piston compressor and one liquid piston expander respectively include an independent operating medium loop, and
wherein hydraulic fluid of all four liquid piston compressors and of all four liquid piston expanders is run in a common hydraulic loop or in two separate hydraulic loops respectively with a hydraulic motor and a hydraulic pump and the Stirling processes in the four operating medium loops are run with a phase shift of a quarter phase relative to one another.

14. The method according to claim 1,
wherein the isothermal compressing step is performed through a liquid piston compressor and the isothermal expansion is performed through a liquid piston expander and the liquid piston compressor and the liquid piston expander impact the same hydraulic fluid, and
wherein the hydraulic fluid exiting the liquid piston expander optionally impacts the liquid piston compressor or a hydraulic motor, or is stored in a pressure vessel through which the liquid piston compressor or the hydraulic motor are loadable with the hydraulic fluid.

15. The device according to claim 7, further comprising:
a hydraulic loop including the liquid piston of the liquid piston compressor or the liquid piston of the liquid piston expander,
wherein the hydraulic loop includes at least one of a hydraulic motor, a hydraulic pump and a vessel.

16. The device according to claim 15, wherein the vessel is a pressure vessel.

17. A method for operating a Stirling cycle process, comprising the following steps:
compressing an operating medium in a compressor in an isothermal manner;
heating the operating medium in an isochoric manner;
expanding the operating medium in an expander is an isothermal manner; and
cooling the operating medium in an isochoric manner,
wherein the compressor is a liquid piston compressor or the expander is a liquid piston expander,
wherein a first valve opens after the compressing step and the operating medium flows from the compressor through the first valve into a heat exchanger and from the heat exchanger through a second valve into the expander, and
wherein a third valve opens after the expanding step and the operating medium flows from the expander through the third valve into the heat exchanger and from the heat exchanger through a fourth valve into the compressor.
